(19) United States
(12) Patent Application Publication
(10) Pub. No.: US 2007/0037123 A1
(43) Pub. Date: Feb. 15, 2007

(54) High-strength dental-implant w/curvilinear-indexing and tool-free delivery-system

(76) Inventors: Robert F. Mansueto, Coronado, CA (US); Robert W. Von Heck, San Diego, CA (US)

Correspondence Address: ROBERT W. VON HECK, 57 TUNAPUNA LANE, CORONADO, CA, 92118, US

(21) Appl. No.: 11/520,307

(22) Filed: Sep. 6, 2006

Related U.S. Application Data
(63) Continuation-in-part of application No. 10/046,000, filed on Oct. 27, 2001.
(60) Provisional application No. 60/243,676, filed on Oct. 26, 2000.

(51) Int. Cl. A61C 8/00

(52) U.S. Cl. 433/173; 433/174

(57) ABSTRACT

An endosseous dental-implant apparatus of enhanced structural strength, simplicity, and installation convenience, the UNI-PLANT™ achieves positive indexing engagement between the primary-implant and its mating secondary-implant member via employment of TRULOCK™,—a male into female indexing-device embodied as either a single abaxial asymmetrical indexer or plural such indexing stations;—discovered to improve strength over other commercially available dental-implant indexing configurations. By employing one or more such smoothly contoured ‘curvilinear’ male/female-indexers the heretofore need of traditional tool-engaging surfaces, such as hexagonal or tri-lobed shapes is advantageously to eliminated;—while also facilitating a novel tool-free delivery system from factory-sealed sterile-vial directly to the patient's oral-cavity. Another advancement to the science of dental-implantation is a unique BIOTITE™ abutment-joint, whereby a slight annular-declivity is formed between interfacing upper and lower shoulders, causing a high-pressure convergence at their perimeter-joint, which provides a biologically-imperforate hyper-swaged seal between the primary and secondary implant members. Additionally, the primary-implant member optionally offers some unique buttress type screw-thread configurations, providing greater resistance to both compressive and lifting forces, and thereby helping to extend the osseointegration life-expectancy of the dental-implant. Therefore with these features optionally combined, the structural-integrity of this dental-implant constitutes the utmost in lasting quality.

### I.) BACKGROUND OF THE INVENTION

1. FIELD OF INVENTION

This invention relates to endosseous type screw-threaded dental-implants for osseointegration; and more specifically it relates to dental-implants of the type employing an essentially two-piece primary-implant and secondary-implant abutment-post assembly, as well as construction devised to provide apex-free indexing and imperforate joining of these two structural members; plus, disclosure relates to systemic methods by which these elements install into a patient's oral-cavity without use of dental-tools.

2. RELEVANT PRIOR-ART

Background research discovery provides some prior patent-art regarded as germane to this disclosure, chronologically for example in early U.S. Pat. No. 943,113(filed: February 1909) is shown a very advanced (for the time) primary-implant shaped tiny lattice-like framework adapted with a slide-on abutment-crown mounting, for insertion into recipient's alveolus; while materials such as gold, silver, platinum, porcelain were proposed, it is believed the structure was prone to gathering bacteria, thereby causing adverse sepsis and necrosis, and so fell into disfavor.

In U.S. Pat. No. 2,112,007 (filed: January 1937) is shown a dental-implant device comprising a primary-implant member having internal screw-threads and at the lower-terminus and initial drainage-passages leading into a central-shaft having female/screw-threads; whereby a screw-threaded rod was subsequently inserted with sufficient screw-threads extending above the implant for attachment of an abutment-post preferably having a ball shaped upper-terminus; thereby providing anchoring for recipient's prosthetic-teeth or a bridge. However, the radial perimeter-shoulder of the implant lacked an exceptionally imperforate perimeter joint-seam by which to resist potential formation of bacterial infection.

In U.S. Pat. No. 4,468,200 (filed: November 1983 from Germany) is shown a primary-implant member having positive-buttress type external/screw-threads and a longitudinal concentric quad-shaped shaft into which is inserted and cemented the lower-shank of an abutment-post; however, it has no provision for preventing the growth of bacteria at the joint between the abutment-post and the radial upper-terminus of the primary-implant.

In U.S. Pat. No. 4,626,214 filed: May 1984 from Spain) is shown a primary-implant featuring positive-buttress external screw-threads and a female/screw-threaded central longitudinal shaft into which was installed a partially screw-threaded shank portion of an abutment-post, and whereto are employed annular O-ring type seals by which to attain a resilient barrier to passage of bacteria;—however, such seals have proven to not address the potential accumulation of bacteria proximal the remaining critical perimeter joint or seam prevailing between the primary-implant's radial-shoulder and the mating radial surface of the abutment-prosthesis.

In U.S. Pat. No. 4,713,004 (filed: September 1986) is shown a primary-implant adapted with an intermediate-abutment which can be canted to desired degree of angularity; including ball&socket as well as fixed-pitch iterations are revealed; in particular however, the primary-implant portion shows a screw-thread (13) configured with an unusual dual-combination of an conventionally upwardly pitched-bottom on one side of the implant-body,—while most notably the opposite side thereof employs a radially flat-bottom, which variably alternates as described continually around the entire extent of the screw-threads.

In U.S. Pat. No. 4,960,381 (filed: August 1988 via CorVent®) is shown a very popular embodiment for a primary-implant, featuring a countersunk wrench engaging internal-hex provision which serves both for wrenching installation and for indexing of the abutment-post;—and while successful in the marketplace, is prone to certain problems (subsequently discussed herein Applicant's instant disclosure).

In U.S. Pat. No. 5,433,606 (filed: July 1993 via CorVent®) is shown a primary-implant embodiment setting forth an upwardly extending male wrenching-hex in contrast to the inventor's preceding opposite female wrenching-hex configuration; but otherwise functions in a similar manner; and includes a screw-threadless body for osseointegration by employing elongate grooves.

In U.S. Pat. No. 5,449,291 (filed: December 1993 via Calcitek-corp.) is shown a primary-implant device which includes an abutment-post having a plurality of radially disposed longitudinal castle-spline like formations which vertically interpose relative to mating castle-spline formations arranged around the upper-terminus of the primary-implant, so as to thereby enable the dentist to select one of to the positions for positive indexing of the abutment; while an assembly retention-screw secures the joined members together.

In U.S. Pat. No. 5,885,079I filed: June 1998 via CorVent-corp.) is shown a primary-implant device which is a modification of the inventor's earlier Pat. # . . . 381 (above), wherein effort is made to improve strength problems (ie:—stripping of the allen-wrench engaging surfaces in the presence of hi-density alveolar-bone); also the inventor addresses various surface-treatments and coatings by which to improve osseointegration of the implant.

In U.S. Pat. No. 5,967,783 (filed: October 1998) is shown a primary-implant setting forth various improvements, including a special alternatingly staggered (called: interleaved) endosseous screw-thread said to promote more rapid osseointegration with recipient's alveolar-bone; while also the longitudinal body of the screw-threaded shank is substantially slimmer than convention, plus the larger of the varied screw-threads are substantially more coarse than what is considered conventional.

In U.S. Pat. No. 6,102,703 (filed: February 1999 by Sulzer-Calcitek corp.) is shown a primary-implant for dental endosseous, wherein is addressed the surface treating and coating of a bio-reactive plasma-sprayed coating identified as preferably HA/hydroxlapatite (calcium-carbonate, sodium-bicarbonate, or partially-crystalline HA-material); while the mating arrangement of the primary to the secondary implant members is substantially according to their above mentioned # . . . 291-patent.

In U.S. Pat. No. 6,142,296 (filed: May 1999 via Lifecore Biomedical) shows a dental-implant packaging system comprising a hermetically-sealed plastic tear-top package containing a dental-implant vial with hinged-cover, whereby upon opening hinged-cover the dental-practitioner sees the head of a tiny capping-screw held in the cap so as to not be lost. However, that is the totality of the offering, there is no further means by which sterility can be assured during subsequent handling for delivery to the patient's oral-cavity. In U.S. Pat. No. 6,149,432 (filed: January 1999 via BioLok-Int'al.) is set forth a particular buttress/screw-thread which is splayed toward the recipient's alveolar-bone, however there is no anticipation of actually employing a negative-undercut to the thread cross-section.

In U.S. Pat. No. 6,183,255 (filed: March 2000) is shown a dental/primary-implant wherein is employed an externally accessible vertical abutment-post retainer-screw arrangement; although the disclosure primarily sets forth the surface is treated with a rutile-crystalline substance tied to HA for example.

In U.S. Pat. No. 6,273,722 (filed: November 1999) is shown a special hybrid cross-threading of a rapid right-hand screw-thread in combination with a rapid left-hand screw-groove, which thus crossover each other's oppositely formed spiral-paths;—which configuration is said to enhance long-term osseointegration.

In U.S. Pat. No. 6,287,117 (filed: April 1999 via SulzerCalcitek-Dental,—who've recently acquired CorVent's pat.-portfolio) is shown a further improvement to the inventors above mentioned U.S. Pat's. # . . . 381 & # . . . 606, and addresses various iterations of subtle abutment-post refinements, in particular thereto being an annular implant top-extender device.

In U.S. Pat. No. 6,733,291 (filed: September 2000 via Nobel Biocare) shows a dental-implant with a tri-lobed internal-indexing configuration, wherein the primary-implant portion employs three equally spaced-apart identical semi-circular lug-recesses which longitudinally receive the three like triad of lug-protrusions, the mated primary and secondary implant members being joined tightly together via a long assembly-screw secured into screw-threads provided deeper into the internal-core of the primary-implant. However, the dental-practitioner is severely limited to re-orientation every 120-degrees azimuth, which might nessitate undesirably disturbing the primary-implants ensconced orientation if the final crown were not aligned quite as desired; also, a special tri-lobed dental-wrench is required to install the primary-implant.

The aforementioned U.S. Pat. No. 4,960,381 by CoreVent® became a highly successful device for endosseous implantation via an external self-tapping male/screw-threaded (or helical) type primary dental-implant portion (anchor), which is set forth with generic-variant embodiments, wherein both a shallow-inset upper female/wrenching-surface (located above the internal screw-threads for indexing of an abutment-post) and an optional deeply-inset (below the screw-threads) female/wrenching-surface is also featured. Additionally, a transversely and longitudinally cross-vented distal-terminus is incorporated (a feature now regarded as not being particularly effective by many dental-implant practitioners); thus the upper internal wrenching-engaging surfaces (of the version available commercially) tends to be necessarily shallow owing to the longitudinal space occupied by the distal-terminus venting construction;—hence is prone to stripping out of registration with its hexagonal (Allen type) wrench cross-section when entering harder bone. Moreover, the six internal 120-degree angulations of the wrenching-surface introduce concentrated stress-load moments-of-force, which apex-corners tend to structurally weaken the overall implant sidewall, even though of high-grade titanium (subject to 2,500-psi. biting-loads,—which can thus equate to concentrated specific-loadings of some 100,000-psi. in these failure prone sidewall internal angulations). The outermost head-portion includes a deep smooth bore opening out contiguously with an uppermost large 45-degree (shown) annular-chamfering contiguous to a slight 30-degree (not identified as having any function other than possibly machine-deburing) perimeter-beveling formed contiguously with the smooth external head's vertical sidewall. The larger inset (45-degree) annular-chamfer is adapted to provide a smooth supporting surface upon which inserts (such as an abutment-post for a prosthetic-tooth) engage upon. The cooperative abutment-post (secondary-implant portion) provided by CoreVent® for use with their primary implant anchor, employs a typical 2 mm-frustum (slightly conical with a flat top) shaped mounting abutment-post, which necessarily includes a hexagonally shaped underside-shank which is inserted down to index into the mentioned wrenching-surface of the primary-implant, thereby preventing inadvertent rotation of the abutment-post (hence undesired rotation of the finally cemented-on aesthetic-prostheses). A tiny sacrificial cinching-screw is installed down centrally through the abutment-post and into the primary implant's internal screw-threads, thereby positively holding the primary and secondary implant members together. However, the wrenching-tool provided by CoreVent® to initially torque the primary-implant into its pilot-hole, is of entirely different size than the smaller allen-tool they provide to subsequently torque the secondary member in place;—which combined with the tiny screw, become more confusing part pieces for an already technically burdened implant-dentist to contend with.

Therefore, in full consideration of the preceding patent review, there is determined need for a simplified form of improved device to which these patents have been largely addressed. We believe this instant disclosure clearly sets forth some newly improved dental-implant features, commercially referred to in general as the UNI-PLANT™ system employing TruLock™, BioTite™, and MAX-Z™,—embodiments currently entering production under auspices of DICOA™/ImplantCentersOfAmerica,—Mfg./Mkt.Co.,—exhibits certain advantageous advancements as shall be revealed in the subsequent portion of this instant disclosure.

### II.) SUMMARY OF THE INVENTION

A.) It is therefore important to make it pellucid to others interested in the art, that a vital object of this invention is to provide a substantially simplified (thus, of lower intrinsic-cost, hence more affordable for the consumer) one-piece endoessous type externally anchoring primary-implant device, and attendant support system components. Therefore, an essential objective of this invention disclosure is to advantageously simplify the often perplexing if excessively costly array of redundant retention-screws and temporary pieces which can not only be confusing to for the practitioner to use, but because of their very tiny size are easily lost if inadvertently dropped. For example, some dental-implant makers absurdly charging upwards of $70 for a mere tiny replacement titanium-screw.

Accordingly, a novel direct-delivery dental-implant system is enabled by our UNI-PLANT™, which is simply packaged factory pre-assembled as a cooperative 3-piece Stage-1 and Stage-2 unit, held together via a longitudinal assembly-screw. These three dedicated implantable precision-made inert titanium members actually comprise the entirety of our basic system,—which utter simplicity has never before been achieved among in the field of dental-implantation;—and is being received by our well-seasoned initial field-evaluation dentists as a tremendous answer to their plea for simplification, rather than the ever increasing complication being introduced by the most prominent dental-implant makers. The UNI-PLANT™ arrives to the dental-practitioner encapsulated within a single inexpensive disposable sterile containment-vial, factory-sealed by a pressed-in plastic/end-cap into which is conveniently arranged first the abutment-post portion of the implant aggregation;—whereby by opening the end-cap the dentist finds the pre-assembled UNI-PLANT™ affixed thereto, and thus merely extracts the UNI-PLANT™ from the vile-body, and while still finger-holding the end-cap transfers the UNI-PLANT™ directly into the patient's prepared/oral-cavity! The special end-cap portion of the containment-vile preferably includes a squared female/longitudinal-receptacle into which is pressed the pre-assembled UNI-PLANT™, the end-cap thus doubling as both a delivery receptacle into which is factory-inserted the squared-shank portion of the UNI-PLANT™ abutment-post,—as well as a handy “direct-driver”;—whereby the dentist never need actually touch the sterile implant-assembly if preferred. Hence, the heretofore single-purpose end-cap, is now given to also logically function as a ‘no-cost’ (was already there but only serving as an end-cap),—and now doubling as a less than inexpensive (free) disposable external finger-held thumb-screw like driver, generally enabling the dental-practitioner working on their patient, to exert sufficient tactile thumb & forefinger rotational-torque, whilst thereby advantageously obviating need for usual costly specialized installation-tools heretofore required by conventional dental-implants.

With this uniquely simplified assemblage, and owing to the inherently light-weight nature of the low-mass driver-base (end-cap), the dental-practitioner is also given to realize the advantage of improved or enhanced tactile-sensitivity during installation into the patient's prepared alveolar-bone;—all the while still able to optionally employ their more conventional external delivery tools if desired (such as when encountering unusually dense alveolar-bone which may require the increased leverage capability of a dental-wrench.). Moreover, this new ‘direct-delivery’ packaging-system serves to virtually eliminate the dental-practitioner's reliance upon their usual manual or powered so-called ‘external-wrenches’ (ie: wrench which fits upon the upended-shank of secondary-implant or abutment-post). Furthermore, the UNI-PLANT™ obviates need for any sort of so-called ‘internal-wrench’ (ie: tool commonly employed to engage the central-core wrenching-surfaces of a conventional primary/dental-implant);—this critical advantage is facilitated by the UNI-PLANT's™ Stage-2 secondary-implant member uniquely serving as its own torquing device during the direct-delivery procedure described in installing the Stage-1 member intact via our unique factory/pre-assembled delivery-system. Additionally, it is preferred that the cylindrical end-cap be provided with a serrated gripping texture (such as a cross-hatching), and that the upper-terminus be optionally formed with a cavity and internal holder (such as a friction-hole) whereby the UNI-PLANT™ primary-implant's tiny healing-screw may be therein contained (preferably with a peel-away foil-cover).

B.) Another object of this invention disclosure is to set forth the novel TRULOCK™ male into female non-lugged indexing device serving to reduce manufacturing-cost by employing low-cost fly-cutting (lateral-milling), thereby eliminating the usual more costly broached formation of longitudinally indexing lugs, or alternately the popular also broached apexed formations such as the internal-hex (ie: Allen-socket) configuration;—while substantially improving the sidewall breakout-strength. In its most elementary form TRULOCK™ achieves indexing of the primary-implant member via one or more unique internal abaxial indexers uniquely configured in plan-view (viewing longitudinally) as tangentially serpentine wave-pattern like curvilinear apex-free formations engaging longitudinally together for positive indexing, wherein the secondary-implant (abutment-post member) itself can operate in conformity with preceding item-A, to actually act as its own unique installation-driver. Accordingly, the TRULOCK™ curvilinear indexing configuration advantageously eliminates the traditionally required internally-engaging wrenching-tool (ref.: U.S. Pat's. # . . . 381 & . . . 079, & . . . 606, by instead employing at least one (asymmetrical), two (symmetrically opposed), or more “involute indexers” (may be odd or even numbered). The two involute indexers thus forming a considered optionally equivalent symmetrically oval-shaped male-into-female version of our most elementary single involute asymmetrical indexer. Conceptually, the most basic embodiment of TRULOCK™ is that employing but a single asymmetric male-indexer into a single female-indexer, however that generally egg-shaped profile embodiment lacked advantage of enabling convenient repositioning;—thus ultimately it was determined the most practical embodiment for TRULOCK™ is one employing a contiguous plurality of male-indexers cooperating with a like plurality of contiguous female-indexers. Although various multiples were tried over a period of time, the present production version employs a plurality of six maleindexers mating into six female-indexers;—thus divisibly equating to an indexing station every 60-degrees of radial-azimuth (ie: the radial-plane of reference being disposed at a right-angle to the longitudinal-axis of the UNI-PLANT™ assembly). Since a greater number of indexing stations provides the dental-practitioner with potentially finer selective repositionings by which to visually determine the best rotational orientation for desired alignment of the final crown (ie: portion permanently-bonded to the abutment-post), then it is possible that future production versions may employ even nine indexing stations (every 40-degrees aximuth) as refinements evolve.

The apex-free curvilinear is easily adapted beneath the lower radial shoulder terminus of the upper body portion of the secondary-implant (abutment member), and actually enable the secondary-implant member to function as the dentist's installation/extraction device. Therefore, unlike the reviewed prior-art requiring use of either standard dental-tools or in any case some form of dedicated non-disposable tool, only the external utility-stud (a preferably 2 mm-square upward projection) of our secondary-implant (abutment-post) itself could optionally lend itself to application of a dentist's wrenching-tool if so desired.

Hence, the advantage of this novel UNI-PLANT™ configuration resides not only in obviating need for the usual costly dedicated throw-away titanium/transfer-tool, typically required by the most popular prior-art implant-systems (such as CoreVent®), but the former problematical internal wrench-tool engaging hexagonal (male/hex-tool into internal female/hex-receptacle) surfaces are hereby eliminated via our TRULOCK™ embodiment,—which smoothly contoured wave-pattern like involute indexing configuration thus being substantially more cost-effective, and essentially overcomes potential dreaded sidewall rupture fractures of the primary-implant.

Procedurally, the UNI-PLANT™ generally follows accepted dental-implant installation practice, the recipient's alveoar-bone pilot-hole is conventionally prepared, and usually includes a precautionary testing-procedure just prior to taking the lab/impression-casting from which the final prosthesis such as a crown is made, and with the secondary-implant (abutment member) tightly secured to the primary-implant, skilled implant-dentists often at their discretion employ a minor re-torquing as a final testing-procedure, basically involving hand tactical-measuring torque-resistance of the primary-implant,—as a way of ascertaining via direct-feedback a “learned feel” for the potential strength of the implant installation. The dentist generally elects to then leave the primary-implant at its most screwed-in position (rather than subsequently backing-off the rotation), and after a satisfactory site-impression is acquired, the secondary-implant abutment is removed and a temporary capping-screw is installed as usual down into the primary-implant, which keeps it internally clean until the patient returns for installation of the final restorative lab-prosthesis (such as a realistic appearing porcelain-crown).

Accordingly, with the UNI-PLANT™ direct-transfer system, if the dentist determines the need to subsequently back-out the primary-implant slightly (or sometimes all the way if a larger size primary-implant is to be substituted), with the secondary-implant (abutment-post) secured in place by the assembly-screw, the dentist merely inverts their conventional dental-wrench, whereby the ratcheting action becomes reversed,—as to conversely ‘unscrew’ the primary-implant as necessary. The initially installed primary-implant can be externally grit-blasted or HA(hydroxylapatite) bio-reactive substrate coated, preferably extending only proximally near the upper-terminus, thereby leaving a polished-neck uppermost portion found to promote healthy mucosal-tissue interfacing. Generally, the primary-implant's ideal positioning is verified via procedural X-ray analysis, whereupon the finally installed primary-implant is thus left alone for several months to stabilize during osseointegration (ie—ensconcing, the bone tissue growing intimately to the HA-coating over a period of about 3-6 months);—preceding the subsequent abutment reconnection for stage-2 completion of the cosmetic crown prosthesis for example. For purposes of component part relationship clarity, it is also important it be understood that reference herein to terms stating upper or lower for example, are thus supposing exemplified installation of the implant invention oriented down into the recipient's mandibular(jaw)-bone;—while naturally such reference orientation would actually become necessarily inverted when installed upward into one's opposing fixed upper-oral facial maxillary-bone structure. The primary-implant portion of UNI-PLANT™ is thus to be regarded as a general minor-surgery implant in support of virtually any accepted manner of dental-reconstruction;—be it in the form of crown-support, bridge-support, or overdenture-support for edentulous or partially-edentulous patients. The entire 3-piece UNI-PLANT™ dental-implant assembly is preferably made of biocompatible medical-grade/titanium-alloy and has won initial FDA-Approval.

C.) Another object of this invention disclosure is to set forth BIOTITE™, a further dental-implant improvement compatible with the preceding items-A&B, wherein the interfacingly abutting surfaces of both the primary and secondary implant members, by employing generally non-parallel radially convergent annular-surfaces forming the shoulders of the respective primary-implant and mating abutment-post members. Owing this unique radial convergence, these interfacing annular edges occlude a slight internally-concealed declivity, enabling only the very outermost interfacing perimeter portions of the abutting primary and secondary implant members to initially impinge, whereupon continued tightening of the assembly-screw squeezes the two members together with such force as to cause a mild-swaging action to occur; whereby as the force of their squeezing together continues, the entirety of both the adjoining outermost radial-surfaces become so intimately impinged that a resultant hyper-swaged condition occurs at the shoulder-perimeter joint from the enormous o force of their abutting one another at this perimeter-point of contact. The declivity (preferably approximately 1-5 degrees radial surface disparity can be provided upon either the top or bottom interfacing radial-surface, or via a matching amount of angular declivity (about 1 to 2½ degrees total disparity convergence) formed oppositely into both if preferred;—the primary object being, to create an internal void which can also become enjoined intimately once the abutment-post is ultimately tightened down upon the ensconced primary-implant anchor. The advantage of this BIOTITE™-abutment configuration resides in its unique ability to more effectively imperforately seal-off the circular perimeter-edges of the abutting members, with tremendous compressive impingement loading, which is advantageously concentrated where the greatest lateral biting-loads become ultimately directed;—and thereby more effectively sealing the abutment-joint (perimeter circular-region of maximum impingement) from any potential entry of biological soft-tissue and fluids which heretofore could possibly host potential endosseous attacking bacteria. Therefore, hyper-swaging involves the primary and secondary interfacing edge surfaces tendency to (in terms of metallurgy) thus essentially “cold-weld” (molecular-fusing) both initially and increasingly over a period of time, owing the outer perimeter impingement always being compressively-loaded relatively higher than the radially inward annular adjoining surface portions.

D.) In view of the foregoing discussion about the earlier invention art as well as the preceding item-A introduction about the basic advantage of UNI-PLANT™, it should be understood that in that regard the actual dental-implant hereof can generally employ any type of conventional osseointegrating lower-body; however, it is preferred that external male helix screw-threading be employed. Moreover in that regard, we preferably employ screw-threads of the reverse-buttress type, and still more preferably of a novel so-called MAX-Z™ “undercut” negative/reverse-buttress configuration, which especially in the case of the latter is uniquely able to provide maximum bite-load support-area shore bracing, owing to the screw-threads extreme bias toward recepient's alveolar-bone (either maxillary or mandibular arch); thereby lending superior resistance to biting compression-loads (which is of particular importance to those installations where the recipient's maxillary and mandibular bone-composition density is characterized as marginal). Note also, that some commercial primary-implants employ external screw-threads of a positive-buttress type (ie:—biased upward away from the lower-terminus of the primary-implant),—a feature thought by some to provide greater resistance of the primary-implant becoming upwardly dislodged from softer alveolar-bone. Generally, most dental-implant designers have simply been proponents of a moderate balanced screw-thread/pitch (having a negative upper-surface declination, and positive lower-surface inclination) or at in some cases a partial reverse-buttress type screw-thread, providing horizontal screw-thread lower-surface portions only on one lateral side of the primary-implant.

This instant-disclosure however, also introduces an optional extreme bias MAX-Z™ configuration, in which the underside of the primary-implant's screw-threads are formed upon its lower-surface with a constantly horizontal (ie: entirely around 360-degrees of spiral-threading) formation, and more preferably even ranging from 1-to-10 degrees neg.-diehedral, as to thereby provide superior shoring-up or “shore-stabilized” screw-thread surface-area. This somewhat umbrella-like negative-dihedral pitch at the underside of the reverse-buttress screw-threads, thereby directing its ultimate resistance toward sustaining compressive biting-loads, rather than customary concern with combating the momentary suction-pull such as when one is chewing-gum for instance. Hence, although presented herein as an optional feature, it is believed the MAX-Z(−) full/reverse-buttress external screw-thread will prove to be an important pre-emptive structural-element in better resisting loosening of the primary-implant, whereby the momentary suction-action uplifting-pull induced such as when chewing upon sticky candy-caramels would not have detrimental effect upon an inherently more solidly anchored primary-implant, owing to a fully horizontal screw-thread underside, and even a more radically preferred, a slightly negatively declining buttress screw-thread.

Another optional embodiment of our MAX-Z™ helix, is our MAX-Z(+) helical screw-thread, which is basically set forth in form of an oppositely biased screw-thread orientation wherein the upper-surface is made at a 0-10 degree continuous positive pitch angle;—thereby facilitating enhanced lift-resistance stabilization of said primary-implant.

Still another optional embodiment of our MAX-Z™ helix, is our MAX-Z(−/+) compound helical screw-thread, wherein is basically set forth a combination of positive and negative buttress types, wherein the lower-surface of the screw-thread in one spiral sector of the helix is formed with an optional 0-10 degree negative declination pitch, while in an alternate sector of the same helix the upper-surface of the screw-thread is formed with an optional 0-10 degree positive inclination pitch. Hence, by incorporating both of these extreme screw-thread buttress formations, and by making transition from one extreme to the other in approximately a half-revolution, the primary-implant is given the ability to facilitate enhanced stability in both compression and lifting conditions. The particular enabling feature in this last embodiment being that the outermost screw-thread edges be maintained at substantially the same vertical interval,—so as to thereby not engage in cross-threading.

A final iteration of our MAX-Z™ screw-thread variations is our MAX-Z(‘DP’) dual-parallel compound configuration, wherein a parallel pair of screw-threads are provided, one being of the negative buttress type having 0-10 degrees declination of the lower-surface, while the other being of the positive buttress type having 0-10 degrees inclination of the upper-surface;—thereby in aggregate providing simultaneously enhanced stability of the primary-implant in both compression and lifting conditions.

### III.) DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the Claims section annexed hereto; and accordingly, a better understanding of the invention and the variant uses is intended, by reference to the drawings, which are considered as primarily exemplary and not to be therefore construed as restrictive in nature; wherein:

FIG. 1, is looking obliquely downward at a vertically-stacked side/elevation-view of a longitudinally disassembled proprietary 3-piece UNI-PLANT™ dental-implant, showing the relationship of the exemplified lower primary-implant with its female-indexers, and an exemplified upper secondary-implant with its male-indexers, and the uppermost assembly-screw;—also noting here that the relative upper and lower locations of the annular wave-patterns of the shown male and female indexers may be relatively invertedly juxtaposed according to engineering design choice;

FIG. 2, is a top/plan-view of the UNI-PLANT™ secondary-implant showing the conventional quadrilateral formation of the 2 mm (or ⅛″) utility-stud with central allen-headed assembly-screw;

FIG. 3, is a side/elevation-view of a longitudinally assembled 3-piece UNI-PLANT™ dental-implant, including uppermost thereto a phantom-outline indication of an exemplified conventional artificial prosthesis;

FIG. 4A, is a top-view of a primary-implant exemplifying ‘Prior-art’ use of a circle of longitudinally broached radial indexing-Lugs, this specimen being FIGS. 1&2 from U.S. Pat. No. 6,733,291;

FIG. 4B, is a fragmented side/elevation-view thereof, whereto internal surfaces of FIG. 4A are indicated via phantom-outline;

FIG. 5A, is a semi-diagrammatic cross-sectional view revealing the fundamental asymmetric single-station version of the stress-relieving TRULOCK™ indexing device shown projected through the central longitudinal-axis via transverse-plane 5:5 in FIG. 3;

FIG. 5B, is a generic-variant embodiment thereof, showing the female-indexer in a slightly elongated pinched oval condition;

FIG. 5C, is a like cross-sectional view revealing the next progression thereof, in form of a symmetrical two-station version of the stress-relieving TRULOCK™ 180-degree azimuth repositionable embodiment;

FIG. 5D, is a generic-variant embodiment thereof, showing the female-indexers in a slightly elongated pinched oval condition;

FIG. 5E, is a like cross-sectional view revealing the next pinched progression thereof, in form of a symmetrical three-station version of the stress-relieving TRULOCK™ 120-degree azimuth repositionable embodiment;

FIG. 5F, is a like cross-sectional view revealing a further pinched progression thereof in form of a symmetrical six-station version of the stress-relieving TRULOCK™ 60-degree azimuth repositionable embodiment;

FIG. 5G, is a like cross-sectional view revealing still further pinched progression thereof in form of a symmetrical nine-station version of the stress-relieving TRULOCK™ 40-degree azimuth repositionable embodiment;

FIG. 5H, is an auxiliary semi-diagrammatic cross-sectional view projected through the central longitudinal-axis via transverse-plane 5:5 in FIG. 3, here exemplifying the single-station male-indexer member which slip-fits into the female-indexer of FIG. 5A;

FIG. 5I, is a like cross-sectional view, here exemplifying the multi-station male-indexer member which is a slip-fit into the female-indexer of FIG. 5F;

FIG. 6, is a reduced-scale partially cut-away side/elevation-view of a separated primary-implant and secondary-implant, showing how orientation of the female-indexer and male-indexer can be invertedly juxtaposed according to engineering-design choice;

FIG. 7A, shown a recent generic-variant of our original TRULOCK™ convoluted male/female-indexer arrangement set forth in FIG. 5A through FIG. 5I wherein the wave-pattern convolutions are formed in azimuth in a uniform horizontally varying in-and-out radiai manner, while in this oblique downwardly observed side/elevation-view the convolutions are demonstrated arranged in azimuth via a alternate uniform up-and-down longitudinally varying wave-pattern formation, and including phantom-outlining of the longitudinal-bore indicating provision for the above poised assembly-screw;

FIG. 7B, is an enlarged semi-diagrammatic side/elevation-view showing in partial cut-away how our radially convoluted TRULOCK™ indexing device can be configured, whereby the surface area of its longitudinally opposed self-centering convolutions can be constantly parallel engaged from the core-bore to the outer perimeter.

FIG. 7C, is a side/elevation-view showing in partial cut-away how our radially convoluted TRULOCK™ indexing embodiment can be positively centered via use of the assembly-screw shank, thereby facilitating alternate employment in combination with our BIOTITE™ perimeter-sealing technique primarily set forth in FIGS. 9A through 9C;

FIG. 8, is a three-phase demonstration, beginning with a partial cross-sectional side/elevation-view of our TRULOCK™ dental-implant exemplifying factory sterile installation into a cylindrical-vial which is sealed via a end cap, and whereto next a dotted/Ref.-line serves to demonstrate how simple finger-grasping extraction of the specially configured cap from the vial facilitates unique sterile tool-free delivery of the factory-assembled dental-implant directly finally into a patient's prepared oral-cavity;

FIG. 9A, is a partial cut-away side/elevation-view showing our optional BIOTITE™ feature, this 1st-sequence establishing the longitudinally opposed relationship approaching impingement;

FIG. 9B, is a fragmented 2nd-sequence thereof, wherein the initially impinging secondary-implant establishes a unique interstitial annular spatial declivity (shown slightly exaggerated for clarity) prevailing between interfacing bottom annular-shoulder of the secondary-implant and top annular-shoulder of lower primary-implant;

FIG. 9C, is a fragmented 3rd-sequence progression thereof, demonstrating resulting hyper-swaging effect of the intimately impinged respective perimeter edges shown forced into a substantially prolapsed condition;

FIG. 10A, is a greatly enlarged partial side/elevation-view detail taken at encircled region 10:10 of generically representative FIG. 3, clearly revealing an optional negative/reverse-buttress configuration of our preferred MAX-Z™ buttress type screw-threading, which embodiment serves to increasingly resist compression-loads;

FIG. 10B, is a greatly enlarged partial side/elevation-view detail also taken at encircled region 10:10 of FIG. 3, clearly revealing an optional positive/reverse-buttress configuration of our preferred MAX-Z™ buttress type screw-threading, which embodiment serves to increasingly resist lifting-loads;

FIG. 10C, is a greatly enlarged partial side/elevation-view detail also taken at encircled region 10:10 in FIG. 3, clearly revealing an optional compoundly alternating Negative and positive configuration of our preferred MAX-Z™ buttress type screw-threading, which embodiment serves to simultaneously offer increased resistance to both compression and lifting load-components;

FIG. 10D, is a greatly enlarged partial side/elevation-view detail also taken at encircled region 10:10 in FIG. 3, clearly revealing an optional compound dual-parallel configuration of our preferred MAX-Z™ buttress type screw-threading, which embodiment serves to offer increased resistance to both compression and lifting load-components.

### IV.) ITEMIZED NOMENCLATURE REFERENCES

10, 10′, 10″, 10F, 10S, 10U, 10L, 10C—primary-implant, lower-sidewall, upper-sidewall, gum-flair, radial-shoulder, upper-terminus, lower-terminus, screw-thread cutter
11, 11′, 11″, 11S—longitudinal-axis, internal-cavity, internal-shaft, female/screw-threads
12, 12′, 12″, 12T, 12S, 12B, 12F, 12H—secondary-implant, utility-stud, tapered-sidewall, lower-terminus, inverted-shoulder, circular-boss, horizontal-flutes, healing-screw
13, 13′, 13″, 13P—abutment-plateau, through-hole, counterbore, cosmetic-prosthesis
14, 14′, 14″14B—conventional assembly-screw, cinching-head, allen-socket, shank-body
15—conventional external screw-threads
16—optional negative/reverse-buttress screw-thread
17—optional positive/reverse-buttress screw-thread
18—optional compound alternating Neg. & Pos. screw-threading
19—optional compound dual-parallel Neg. & Pos. screw-threads
20,20′/20″,20D,20J,20P—interstitial-annulus, perimeter-edge: primary/secondary, declivity-angle, joint, parallel-interfacing
21,21′/21″,21S—female-indexer, low-point/high-point, side-wall (vertical or tapered)
22,22′/22″,22S—male-indexer, low-point/high-point, side-wall (vertical or tapered)
23,23′/23″,23C—radial-indexer convolution: perimeter, low-pt./high-pt., conical-base
24,24′/24″—upper-shank body, azimuth adjustment ref.arrows: incremental/continuous
25′/25″—cinching-action ref.arrow: initial (fragmented-arrow)/final (solid-arrow)
26—hyper-swaging action compressive-force ref.arrows
27,27′,27″,27M,27C,27E,27H—delivery-module: vial, base-flange, side-wall, vial-mouth, internal-confines, screw-enclosure, screw-holder
28,28′,28″,28P,28C—extraction-cap, finger-knob, retention-fingers, ret.-prongs, cover
29,29′,29″,29D—alveolar-bone, gum-tissue, pilot-hole, factory-assembled dental-implant
30,30′,30-30R,30A,30C,30S,30E—Prior-art: primary-implant, upper-sidewall, radial-shoulder, lug-recess, lug-apex, core-shaft, internal screw-threads, external screw-thread

### V.) DETAILED DESCRIPTION OF THE PREFERRED EMBODIMENTS

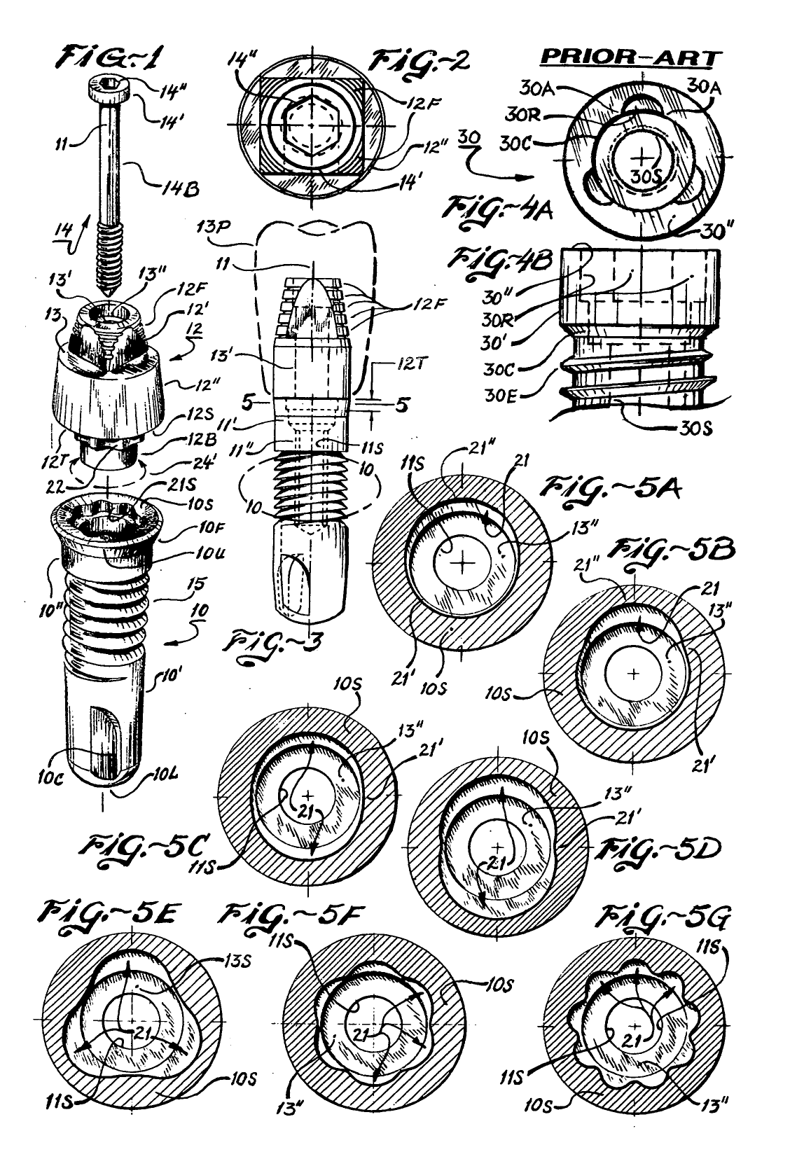

Initial reference is given by way of FIG. 1 wherein is exhibited the preferred TRUELOCK™ dental-implant embodiment of this disclosure, shown in a vertically arranged array of cooperating members identified as the primary-implant 10, and immediately thereabove its secondary-implant member 12, while poised uppermost is an assembly-screw 13;—whilst longitudinal-axis 11 extends centrally through the entire disassembled aggregation. Externally, the primary-implant 10 appears substantially conventional, for example the lower-sidewall portion 15 may simply embody a plain HA-coating only, but preferably includes a conventional screw-thread 15″ and a conventional cutting-relief 15′, while the upper-sidewall portion may be highly-polished and shaped with an annular gum-flair formation 10F. The primary-implant's upper-terminus 10U makes abrupt transition into radial-shoulder 10S, wherein is provided a downwardly formed novel female-indexer 21 which cooperates positively with a mating male-indexer 22 provided upon the underside of secondary-implant 12. The secondary-implant 12 generally employs a conventional utility-stud 12′ having central through-hole 13′ provided with counterbore 13″ made into its top-surface (also see auxiliary-view FIG. 2); the utility-stud 12′ being integrally formed atop abutment-plateau 13, is also preferably provided with cement-filling horizontal-flutes 12F, below there a conventional slightly tapered sidewall portion 12″ extends down to its maximum diameter lower-terminus 12T. Note that inverted-shoulder 12S supports a multi-convoluted male-indexer 22, here exemplified as employing seven indexing-stations, which is of sufficient vertical extension (at least 0.15 mm) of sidewall surface 22S as to provide sufficient rotary-torquing resistance,—while preferably jutting down still further centrally from the male-indexer 22 is an optional integral circular-boss 12B which simultaneously slips down into the optional internal-cavity 11′ of the primary-implant (however if preferred, the downward protrusion to lower-terminus 12T can be solely that of the male-indexer 22). The attendant circularly-broken ref.arrows 24′ indicating how the convoluted iterations of the TURLOCK™ male into female indexers are incrementally adjustable as to azimuth orientation. Reference to FIG. 3 shows the same dental-implant in fully-assembled condition, including phantom-outline indication of a finished custom-crown prosthesis 13P fitted atop thereto. Note here that the preferred vertical-depth: ‘X’ of the primary-implant's female-indexer is by way of general comparison about 0.25 mm.

Next, in the family sequence of FIGS. 5A/5B/5C/5E/5F/5G is shown a progression of female-indexers 21, beginning with the most elementary embodiment of FIG. 5A,—wherein is revealed a single assymetric oval-shaped female-indexer formation, while in FIG. 5B is shown a slightly elongated generic-variant thereof including an optional slight pinching 21P option. In FIG. 5C is shown a further variant of FIG. 5A in the form of an asymmetric-oval which thereby facilitates a second 180-degree repositioning station as to azimuth-repositioning indicated in FIG. 1 via circular ref.arrows 24;—while in FIG. 5D is shown a centrally opposed slight pinching 21P as well. Accordingly, FIGS. 5E/5F/5G show still further progressions as to how the convolutions thus become spatially smaller in progressions of three female-indexers, six female-indexers, to a believed practical limit of about nine female-indexers as is set forth in FIG. 5G. The allied embodiments of FIGS. 5H/5I serve to exemplify how the TRULOCK™ male-indexer essentially employs the same visual contouring as its female-indexer counterpart,—albeit slightly smaller as to facilitate a precision slip-fit into its mating female-indexer;—the male example of FIG. 5H thus fitting positively into the female example of FIG. 5A, and male example of FIG. 5I fitting into the female example of FIG. 5I,—and so on.

Moreover, it is critical to note how our TRULOCK™ female-indexer and male-indexer combination uniquely facilitates the total absence of herefore so-called apex stress-risers such as are created by lug-apex 30A present in the Prior-art example of FIGS. 4A/4B;—the smoothly configured TRULOCK™ dental-implant's indexing device is critically entirely free of such abrupt side-wall incursions. Observe in FIG. 4A that while the lug-apex incursions 30A are inwardly-directed, instead of outwardly-directed as in the case of the well known internal-hex formation,—the three identical lugs are relatively costly to produce as compared to the TIRULOCK's™ smooth inexpensively flycut male and female convolutions,—which evolved from the TRULOCK™ species genus embodiment of FIG. 5A. Hence, while the Prior-art example of FIGS. 5A/B enables the same three azimuth reorientation limitations as the TRULOCK's™ FIG. 5E example,—the Prior-art example lacks the advantages being set forth by the TRULOCK™ dental-implant. The side-elevation view of FIG. 6 primarily serves to demonstrate how the aforestated relative locations of the female-indexers 21 and the mating male-indexers 22 may be factory juxtaposed according to engineering-design choice without materially altering the functionality of these cooperating elements.

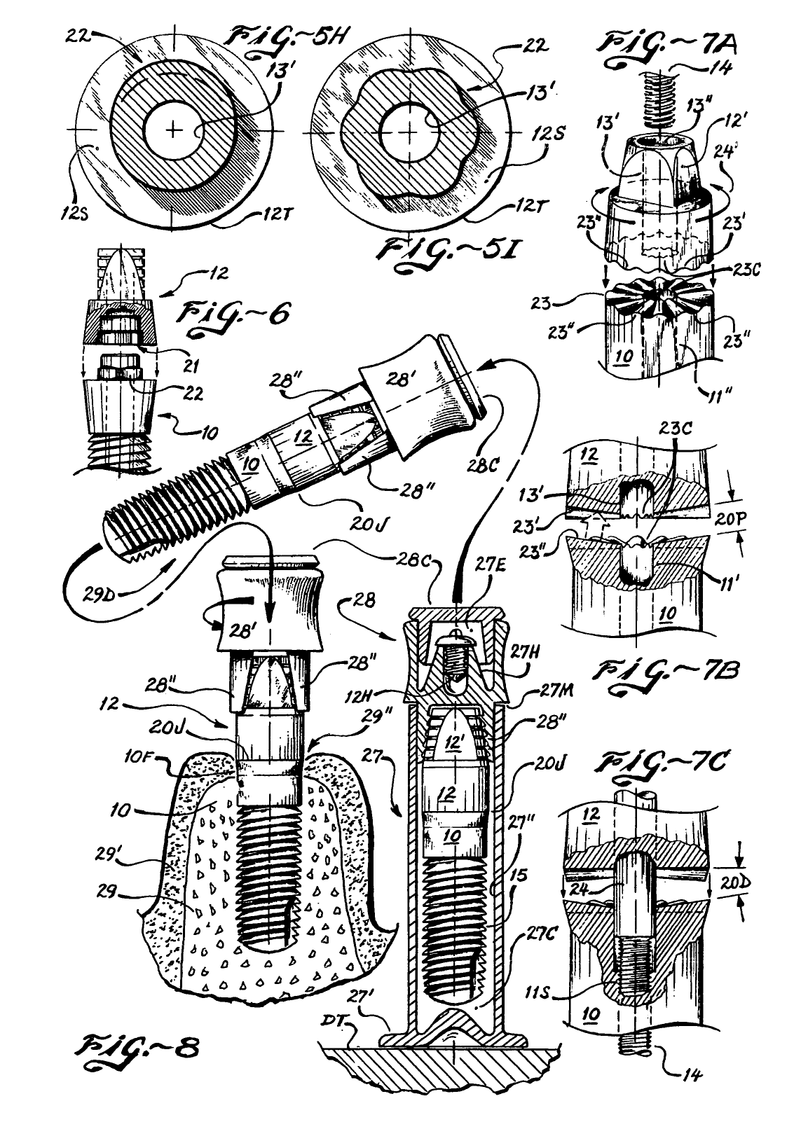

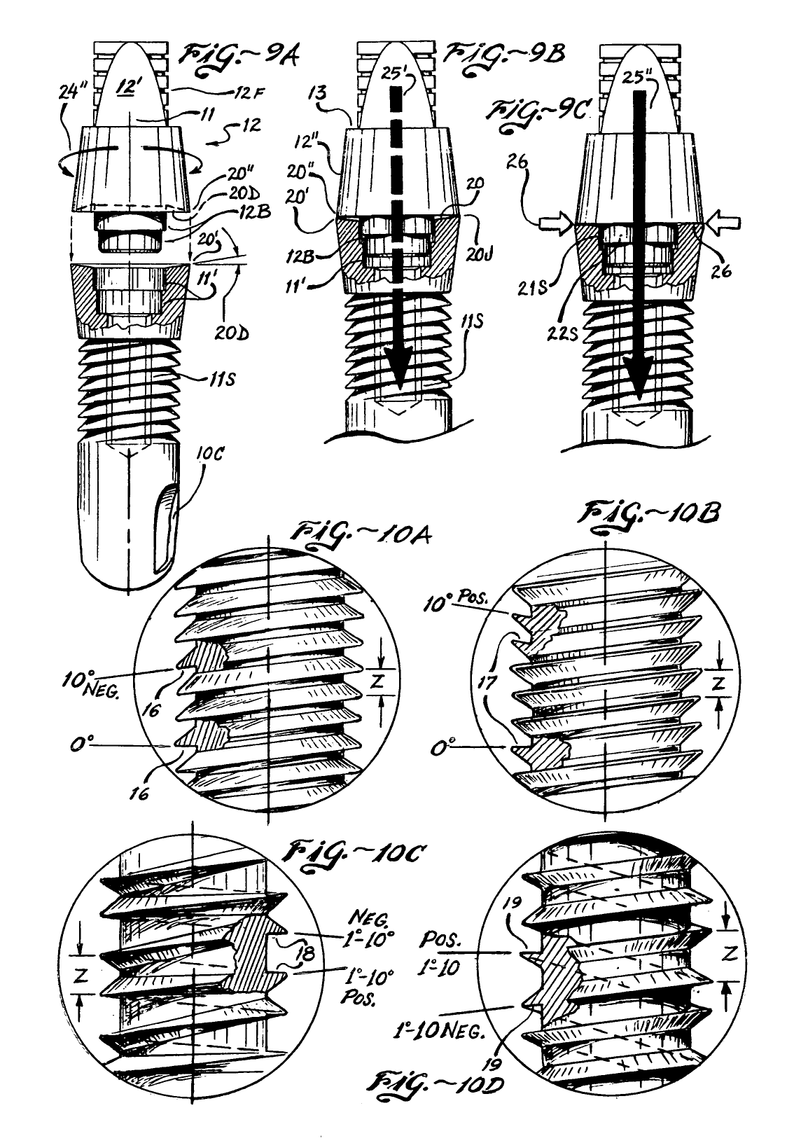

In related FIGS. 7/7B/7C is introduced a more recently evolved generic-variant adaptation of the TRU-LOCK™ positive indexing device, wherein FIG. 7A shows how the precedingly vertically oriented convolutions have been effectively splayed or fanned radially outward so as to achieve an alternate embodiment, which potentially offers the primary advantage of the dentist realizing a finer azimuth repositioning of the secondary-implant, without therefore necessarily disturbing the primary-implant's screwed position. The believed practical limit of twelve (12) indexing positions is exhibited here,—providing for reorienting of the secondary-implant in 30-degree increments, as compared to 40-degrees for the proposed nine (9) indexing positions exhibited by the FIG. 5G iteration (while presently the TRU-LOCK™ equipped INI-PLANT™ dental-implant is being produced as a six-station embodiment). Next, FIG. 7B serves to demonstrate how the substantially identical lower convolutions of the primary-implant 10 and parallel-interfacing 20P upper convolutions of the secondary-implant 12 actively engage along the span of the individual convolution radiating from the smaller inward conical-base region 23C to the large outward high-point 23″;—the primary-implant's internal-shaft 11″ and secondary-implant's through-hole 13″ thus being placed in precise longitudinal-alignment by inherent function of the self-aligning upper and lower impinging radial convolutions, whilst the assembly-screw 14 of FIG. 1 as usual secures the secondary-implant down rigidly upon the primary-implant 10. In the diagrammatically exaggerated FIG. 7C is shown how the upper and lower convolutions may be made formed divergently (or convergently as it were) so as to thereby create an interstitial-annulus 20 (spatial void) via declivity-angle 20D thereby impinging only around perimeter-edges 20′ and 20″ (noting again that the relative convergence or declivity-angle 20D is here greatly exaggerated,—as it need only be about 2-degrees in order to create an imperforate perimeter joint as shall be elaborated upon in subsequent FIG. 9). However, in order to make the FIG. 9C iteration work in perfectly maintained rigid longitudinal alignment, a assembly-screw 14 made with a special integral precision slip-fit upper-shank portion 24′ is required so as to prevent lateral shifting of the tightly impinging perimeter-edge portions 20′ and 20″.

The three-phase diagrammatic illustration of FIG. 8 effectively demonstrates the simple albeit surprisingly effective ‘tool-free’ delivery-system enabled by the UNI-PLANT™ dental-implant factory-packaged delivery-module system. The first-phase being revealed at the right of FIG. 8, where we see a cross-section of the preferably transparent plastic or glass vial 27, preferably including a horizontally flanged radial-base 27′, which thus enables the factory hermetically-sealed vial 27 to stablely rest vertically at the ready upon a conventional arm-supported dental-tray ‘DT’ represented immediately below the vial. Both the internal-confines 27C of vial 27 along with the entire exemplified factory-assembled dental-implant unit 29D (such as that substantially shown in FIG. 3,—or a conventional version thereof) are fully sterilized before leaving the factory-facility; and the dental-implant 29D is thus held therein dependent from the underside retention-fingers 28″ of extraction-cap 28. The dentist (or dental-assistant,—whom has already removed a conventional unshown factory shrink-wrap circumferential-band seal) can thus easily place two fingers firmly astraddle the vial side-wall 27″, while with their free hand grasps the comfortably human-engineered concave-perimeter of the finger-knob 28′ portion of extraction-cap 28, then firmly withdrawingly lifts extraction-cap 28 from vial-mouth 27M. At this juncture, the delivery-system consists primarily of just the special extraction-cap 28 and the factory-assembled dental-implant 29″ which is held fast to the retention-fingers 28″ (there are preferably four such opposing fingers) preferably having tiny claw-like retention-prongs 28P,—which enhance the friction holding capability of the retention-fingers 28″ by impinging into undercut horizontal-flutes 12F preferably provided around the utility-stud of the secondary-implant (also ref. FIG. 2), and thus in addition to the friction-fit of the retention-fingers 28″ the retention-prongs 28P effectively cling to the underside of the horizontal-flutes 12F;—therefore reliably maintaining otherwise untouched sterility of the dental-implant unit 29D as it is being transferred (represented by the near horizontal attitude of the delivery-module portion at the upper region of FIG. 8) to the patient's previously prepared pilot-hole 29″. Accordingly, the third-phase of the UNI-PLANT™ tool-free delivery-system is represented at the left-side of FIG. 8, whereto the dashed/reference-arrow makes lateral-transition into a rotational-action ref.-arrow on the left side of the finger-knob 28′, indicating dexterous clockwise finger-tip rotation of the still intact extraction-cap 28 as to thereby screw the appended dental-implant 29D down into the gum-tissue 29′ and alveolar-bone 29 pilot-hole 29″ via the conventional screw-thread cutter 10C provided at the lower-terminus 10L of the primary-implant portion. Once the thus fully sanitary transfer of the dental-implant 29D has been thus initiated, the dentist thus continues to finger-screw the dental-implant 29D down to the desired depth as shown;—although in some instances of particularly dense alveolar-bone 29 the dentist may elect to detach the extraction-cap's retention-fingers 28″ from the utility-stud 12′ of a partially installed dental-implant 29D,—so as to complete the screwing-in procedure by applying their existing conventional ⅛-inch utility-stud dental-wrench. An optional provision of the extraction-cap 28 is a friction-fitted pop-off cover 28C which conceals the temporary healing-screw 12H secured into screw-holder 27H protruding up from the screw-enclosure 27E;—and this conventional healing-screw 12H is finally screwed into the slightly exposed primary-implant's upper-terminus 10U once the secondary-implant has been temporarily removed (prior to eventual installation of a dental-prosthesis thereto). The inexpensive delivery-module comprising the leftover vial 27 and extraction-cap 28 are regarded as disposable.

Moving on to the sequential progression of FIGS. 9A/9B/9C, wherein is presented our novel BioTITE™ enhanced perimeter sealing of the joint 20J created by the secondary-implant 12 interfacing down toward the primary-implant 10. In pre-assembled FIG. 9A is shown perhaps the ultimate embodiment of the BIOTITE™ principle,—the BIOTITE'360™; wherein is revealed a non-incremental continuous 360-degree azimuth rotation of the secondary-implant is now made possible owing the positioning quality of so-called hyper-swaging action occurring around the respective joint perimeters 20′ and 20″ (also see FIGS. (9B/9C). Hence, by virtue of a slight perimeter-convergence declivity-angle of approximately 1-5 degrees, a tremendous perimeter point-contact pressure is attained as the assembly-screw cinches the interfacing perimeters together;—which resultant hyper-swaging action is preferably further increased by use of a larger diameter assembly-screw employing a finer screw-thread pitch as to thereby increase the perimeter compressive loading to the extent that it has been discovered that the heretofore use of male/female-indexing methods can be completely eliminated without fear of the secondary-implant slipping out of desired selected registration. The obvious advantage of eliminating male/female-indexing members resides in enabling the dentist to simply secure the final cosmetic-prosthesis at the most desired azimuth-orientation without the compromised hinderance imposed by traditional incremental-indexing;—yet improved lateral-stability and reduced manufacturing-cost are also residual bonuses. The secondary-implant 12 member of the BIOTITE'360™ type dental-implant is rigidly centered longitudinally via an integral circular-boss 12B; noting also that the novel declivity-angle 20D shown formed into the primary-implant's radial-shoulder 10S is shown somewhat exaggerated for purpose of visual clarity, as is the optional opposing declivity-angle indicated via phantom-outline likewise formed into the opposing secondary-implant's inverted-shoulder 12S.

In subsequent FIGS. 9B and 9C the basic principle of the BIOTITE™ mechanism is demonstrated, albeit here in combination with the TRU-LOCK™ male/female indexing members (otherwise, FIG. 9A features are common);—nevertheless, the BIOTITE™-principle itself remains the same regardless as to being of rotationally continuous or incremental design adaptation. Accordingly, in FIG. 9B the secondary-implant member is shown in its initially seated condition,—wherein one can observe the now occluded perimeter joint 20J and the resultantly created interstitial-annulus 20; noting that the greater the pitch of the declivity-angle 20D, the larger the resulting interstitial-annulus 20 (which can be created via only the lower/declivity-angle, or only an upper/declivity-angle,—or a combination of them both). The longitudinal bold/broken-arrow of FIG. 9B serves to indicate the secondary-implant 12 (ref. here unshown assembly-screw 14 of FIG. 1) is exerting very little downward force, while the longitudinal solid/bold-arrow of subsequent FIG. 9C serves to indicate that the assembly-screw has been torqued-down to its full extent, thereby compressing the perimeters 20′ and 20″ into final prolapsed-condition; whereby the interstitial-annulus 20 has been shown almost entirely eliminated, only a vestigial inwardmost remnant of the interstitial-annulus 20 remains,—as is referenced via the large left and right opposed white-arrows (while presence of the assembly-screw has been omitted for sake of visual clarity).

Reference to a related series of four generic-variant MAX-Z™ buttress type external/screw-threads is provided in FIGS. 10A/10B/10C/10D, the first embodiment of FIG. 10A being that of an undercut negative/reverse-buttress 16 designated Max-Z(−), wherein it is shown that the exemplified generic screw-thread region encircled in FIG. 3 features an extreme bias directed toward the lower-terminus of the dental-implant. In this configuration the lower-surface (underside) of the screw-thread is formed at a pitch ranging from the horizontal (0-degrees as shown, but more preferably at a pitch-angle of between 1-to-10 degrees from the horizontal;—hence affording the maximum amount of resistance to compressive-loads when biting. In FIG. 10B is set forth is that of an oppositely biased positive/reverse-buttress 17 external/screw-thread orientation designated the Max-Z(+) type, wherein it is shown that the exemplified generic screw-thread encircled in FIG. 3 features an extreme bias directed toward the upper-terminus of the primary-implant, whereby the upper-surface is made at a pitch-angle of between 1-to-10 degrees from the horizontal;—hence affording enhanced lift-resistance stabilization of the dental-implant. In FIG. 10C is set forth that of a compound helical external/screw-thread alternating Pos. and Neg. screw-threading 18 designated the Max-Z(−/+) type, wherein is provided the novel combination of both a negative-buttress and a positive-buttress types; whereas the lower-surface of the screw-thread in one spiral-sector of the helix is formed with an optional 0-10 degree negative declination pitch, while in an alternate spiral-sector the upper-surface is formed with an optional 1-10 degree positive inclination pitch. And lastly, in FIG. 10D is set forth that of a dual-parallel compound Neg. and Pos. external/screw-threading 19 designated the Max-Z(‘DP’) type;—whereto one of the screw-threads is of the negative-buttress type (as in FIG. 10A), while running immediately next to it is a screw-thread of the positive-buttress type (as in FIG. 10B);—hence, affording simultaneously enhanced stability of the dental-implant in both compression and lifting conditions. Note also, that regardless as to the variations in upper-surface and lower-surface pitch-angularity, the outermost perimeter-edge of the screw-threads always maintains a constant spiral-interval ‘Z’;—thereby insuring that the once cut-away alveolar-bone (for example) is being substantially filled with screw-thread, regardless as to its particular pitch-angle (the principle being that once the HA-coating provided upon the primary-implant has achieved osseointegration after a period of time, the patient's bone-material will have fully complied to the relatively minor pitch variances, being that the essential pattern of the screw-thread spiral-interval ‘Z’ is necessarily satisfied.

Thus, it is readily understood how the preferred and generic-variant embodiments of of our UNI-PLANT™ dental-implant invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended Claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

What is claimed of proprietary inventive origin is:

1. An improved dental-implant configuration; said dental-implant comprising:
a rigid elongate shank with longitudinal-axis forming a primary-implant having a lower external retention means for anchoring into recipent's endosseous pilot-hole, including an upper-sidewall portion thereto extending to upper-terminus thereof, whereto an internal-core extends longitudinally down into said upper-terminus wherein one or a plurality of apex-free abaxial female-indexer means provide positive engagement relative to a secondary-implant member having a utility-stud means with a longitudinal through-hole whereto at the base thereof is included one or more longitudinally mating critically apex-free abaxial male-indexer means; plus an assembly-screw extending within said through-hole securing into female/screw-threads provided lowermost within said internal-core thereby tightly cinching said secondary-implant to said primary-implant as a dental-implant assembly.

2. The dental-implant according to claim 1, wherein said female-indexer means is characterized in top-view cross-section as an asymmetric-oval in single station embodiment, or characterized as a symmetrical-oval in dual-opposed station embodiment, or characterized in plurality of three or more such apex-free stations as a smoothly tangential serpentine like convoluted wave-pattern of identical stations.

3. The dental-implant according to claim 2, wherein said male-indexer means is characterized in bottom-view cross-section as an asymmetric-oval in single station embodiment, or characterized as a symmetric-oval in dual-opposed embodiment, or characterized in plurality of three of more such apex-free stations as a smoothly tangential serpentine like convoluted wave-pattern of identical stations.

4. The dental-implant according to claim 1, wherein sidewalls of said female-indexer and said male-indexer are formed vertically hence parallel with said longitudinal-axis; or, their respective said sidewalls may be formed tapered slightly inward toward lower-terminus of said primary-implant as to thereby facilitate easier indexing of said secondary-implant member.

5. The dental-implant according to claim 1, wherein said utility-stud includes tiered horizontal-flutes means, said horizontal-flutes facilitating engagement of an extractor-cap means for dependent holding of the factory-assembled dental-implant within a sterile delivery-module vile, said extractor-cap including an integral finger-knob means by which dentist may grasp extractor-cap and execute direct-delivery of the dental-implant into a patient's prepared oral endosseous pilot-hole, then proceed to rotate dental-implant using extractor-cap as a direct-driver; thereby obviating need of conventional dental-tools so as to simplify installation of the dental-implant.

6. The dental-implant according to claim 1, wherein optional said plurality is preferably six to nine equally spaced apart indexing stations; the greater number of stations enabling advantageously finer azimuth repositioning of said secondary-implant.

7. The dental-implant according to claim 1, wherein said female-indexer means and said male-indexer means locations are invertedly juxtaposed, whereby the primary-implant member provides said male-indexer means and the secondary-implant member provides said female-indexer means, while said assembly-screw still secures said secondary-implant; thereby resulting in substantially equivalent functional performance according to engineering-design choice.

8. The dental-implant according to claim 1, wherein said external retention means is a helical screw-thread longitudinally encircling said primary-implant's body.

9. The helical screw-thread according to claim 8, which is of the negative-buttress type, wherein the lower-surface of said screw-thread is formed at an optional 0-10 degree continuous negative declination pitch; thereby facilitating enhanced compression-resistant stabilization of said primary-implant.

10. The helical screw-thread according to claim 8, which is of the positive-buttress type, wherein the upper-surface of said screw-thread is formed at an optional 0-10 degree continuous positive inclination pitch; thereby facilitating enhanced lift-resistant stabilization of said primary-implant.

11. The helical screw-thread according to claim 8, which is of a combination negative and positive buttress types, wherein the lower-surface of said screw-thread in one sector of said helix is formed with an optional 0-10 degree negative declination pitch, and in an alternate sector of said helix the upper-surface of said screw-thread is formed with an optional 0-10 degree positive inclination pitch; the combination thereby facilitating enhanced stability of said primary-implant in both compression and lifting conditions.

12. The helical screw-thread according to claim 8, wherein said external-retention means is a combination dual-parallel helix pattern, wherein one screw-thread is formed with optional 0-10 degree negative buttress for compression-resistance, while the other screw-thread is formed with optional 0-10 degree positive buttress for lift-resistance.

13. The dental-implant according to claim 1, wherein the interfacing shoulders of said primary-implant and said secondary-implant are of identical diameter and formed to provide an interstitial annular declivity, thereby abutting their respective outer perimeter-edges; whereby, tightening said assembly-screw concentrates perimeter point-contact pressure inducing so-called swaging-action imperforately sealing the joint from bacterial formation, while providing improved lateral stability of said secondary-implant.

14. The dental-implant according to claim 1, wherein said secondary-implant includes a conventional square-shaped utility-stud to which may be adapted any one of variously configured attachments such as a custom crown or bridge.

15. A dental-implant for supporting an artificial-tooth structure, with improved bacteria blockage, said dental-implant comprising:
a rigid elongate shank with central longitudinal-axis forming a primary-implant having a lower external retention means for anchoring into recipient's endosseous, and including a smooth upper-sidewall portion thereto extending to said upper-terminus whereto a radial-shoulder means is formed annular to an internal-core formed coaxially down into said upper-terminus, and a secondary-implant member with lower-terminus having inverted-shoulder means circumferentially engaging with opposed said radial-shoulder thereby providing a slight internal declivity means whilst abutting around their respective outer perimeter-edges; said secondary-implant including a coaxial through-hole for assembly-screw securing into female/screw-threads provided in lower-terminus of said internal-core; whereby as said assembly-screw is tightened the resulting concentrated annular perimeter point-contact pressure induces a so-called swaging-action which imperforately seals the joint from formation of bacteria, while providing enhanced lateral stability of said secondary-implant.

16. The dental-implant according to claim 15, wherein is included a circular-boss means enabling continuous non-incremental azimuth rotation of said secondary-implant member to suit visual preference of dental-practitioner, whereupon tightening of said assembly-screw ultimately fixes said secondary-implant in selected azimuth orientation.

17. The dental-implant according to claim 16, wherein primary-implant's said internal-core is adapted with one or more abaxial apex-free female-indexer means configured in plan-view with a pronounced circular convoluted wave-pattern formation, whereto is longitudinally received a positively indexing like said male-indexer means of said secondary-implant member.

18. A tool-free delivery system for sterilely installing a dental-implant assembly into a pilot-hole provided in recepient's endosseous; said system comprising:
providing a sterile disposable vial containing a sterile factory pre-assembled primary-implant and sterile secondary-implant held longitudinally assembled via a sterile assembly-screw all hermetically sealed therein said vial via an inwardly sterile extraction-cap having retention means for holding the dental-implant assembly dependent therefrom, whereby dental-practitioner or assistant holds vile in one hand while grasping external finger-knob portion of said extractor-cap in fingers of other hand, thereby withdrawing dental-implant assembly therefrom said vial, and thereby transferring dental-implant directly into patient's prepared endosseous pilot-hole, whereupon dual-purpose said extractor-cap becomes an instant direct-driver which is finger rotated therein into pre-determined depth; said extractor-cap is then manually disengaged from utility-post of said second-stage member, whereupon disposable said vial and extractor-cap may be discarded; thereby substantially streamlining dental-implant installation procedure by obviating more complicated use of conventional dental-tools during which sterility of said primary-implant can become contaminated.

19. The tool-free delivery system according to claim 18, wherein said retention means comprises laterally opposed resilient longitudinal retention-finger means integrally molded to underside of said extractor-cap; which thus physically grip the utility-stud of said secondary-implant.

20. The retention-fingers according to claim 19, wherein are included a plurality of tiny retention-prong means which engage into horizontal-flutes provided upon the sides of secondary-implant's utility-stud; thereby increasing holding power of retention-fingers.
